(19) United States
(12) Patent Application Publication
(10) Pub. No.: US 2023/0347920 A1
(43) Pub. Date: Nov. 2, 2023

(54) AUTONOMOUS VEHICLE NOTIFICATION SYSTEM

(71) Applicant: Motional AD LLC, Boston, MA (US)

(72) Inventors: Bence Cserna, Nahant, MA (US); Linh Pham, Boston, MA (US); Felice Ling, Cambridge, MA (US)

(21) Appl. No.: 18/140,848

(22) Filed: Apr. 28, 2023

Related U.S. Application Data
(60) Provisional application No. 63/336,802, filed on Apr. 29, 2022.

(51) Int. Cl. B60W 50/14; B60W 50/00

(52) U.S. Cl. CPC B60W 50/14; B60W 50/0097; B60W 2554/404; B60W 2556/10; B60W 60/0027

(57) ABSTRACT

An autonomous vehicle notification system, method, and a computer program product. One or more travel trajectories associated with at least one of a vehicle and at least one object present in an environment of the vehicle are determined. A presence of at least one event occurring in the environment of the vehicle is detected. A determination is made that the detected event meets a notification threshold. At least one notification in a plurality of notifications for presentation using at least one user interface component of the vehicle is generated. The notification corresponds to the detected event. The generated notification is selectively presented using the user interface component.

### CROSS-REFERENCE TO RELATED APPLICATIONS

The present application claims priority to U.S. Provisional Patent Appl. No. 63/336,802, filed Apr. 26, 2022, and incorporates its disclosure herein by reference in its entirety.

### BACKGROUND

An autonomous vehicle is capable of sensing its surrounding environment and navigating without human input. Upon receiving data representing the environment and/or any other parameters, the vehicle performs processing of the data to determine its movement decisions, e.g., stop, move forward/reverse, turn, etc. But the reasons behind selection of movement decisions can be difficult to communicate to passengers.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5 is an example notification system, according to some embodiments of the current subject matter;

FIG. 6 illustrates an example table showing various levels of priority and/or severity that may be assigned to a particular uncertainty event;

FIG. 7 illustrates an example environment for determination of relevance of each agent, according to some embodiments of the current subject matter;

FIG. 8 illustrates examples of event triggers that may be used to generate various notifications that may be displayed using the user interface component shown in FIG. 5;

FIG. 9 is an example notification customization graphic; and

FIG. 10 illustrates an example notification process, according to some embodiments of the current subject matter.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

A vehicle (e.g., an autonomous vehicle) includes various computing systems, such as, for example, sensors that monitor various parameters associated with the vehicle, processing components that perform various functions associated with operation of the vehicle (e.g., determining vehicle's maneuvers, etc.), and/or any other components. For example, some sensors (e.g., cameras, LIDAR sensors, RADAR sensors, SONAR sensors, etc.) monitor/detect changes occurring in the vehicle's environment (e.g., actions and/or presence of other vehicles, pedestrians, street lights, etc.). The information/data received from the sensors is used by the vehicle's controller (or any other processing component) to determine path of travel, direction, speed, and/other movement parameters, which may be used by other components for execution. Each of the above components may be disposed on and/or be part of an integrated circuit and its performance may be monitored by one or more monitoring processor cores.

In some embodiments, the current subject matter relates to a notification system that selectively presents notifications to passengers, riders, and/or users inside the autonomous vehicle (AV). A motion planner and/or any other AV component may determine one or more travel trajectories associated with at least one of the vehicle and at least one object present in an environment of the vehicle. A presence of at least one event (e.g., pedestrian crossing the road, etc.) occurring in the environment of the vehicle may be detected. A determination may be made that the detected event meets a specific notification threshold (e.g., the detected event is significant enough to report to the passenger). This determination may be made based on various levels of severity and/or priority, as discussed below. For example, higher priority and/or severity events (e.g., animals darting in front of the vehicle causing the vehicle to abruptly stop, etc.) may have a higher threshold. Lower priority and/or severity events (e.g., noises detected by the vehicle that do not affect its ability to operate, etc.) may have a lower threshold to meet. At least one notification in a plurality of notifications for presentation using at least one user interface component of the vehicle may be generated. The notification may correspond to the detected event. The notification may be selectively presented to the passenger, rider, user, etc. (e.g., based on user preferences) using the user interface component.

In some embodiments, the current subject matter may include one or more of the following optional features. The event may be associated with at least one agent (e.g., object) in a plurality of agents. The determined travel trajectories may include: a current trajectory, a historical trajectory, a predicted future trajectory, and any combination thereof.

In some embodiments, the object may include at least one of the following: a moving object, a non-moving object, a stationary object, and any combination thereof.

In some embodiments, the notification may be generated for a plurality of events including the detected event. (e.g., notifications may be generated about groups of events).

In some embodiments, the selectively presenting may include determining one or more preferences (e.g., user preferences) associated with presenting one or more notifications in the plurality of notifications, and executing, using the one or more determined preferences at least one of presenting the generated notification using the user interface component, and preventing presentation of the generated notification using the user interface component.

In some embodiments, the travel trajectories may include at least one of the following: a travel trajectory unassociated with the object, a travel trajectory associated with the at least one object, a travel trajectory executed by the at least one object, and any combination thereof.

In some embodiments, the generating may include determining at least one of a priority and a severity of the at least one detected event. The selectively presenting may include presenting at least one generated notification in accordance with at least one determined priority and severity of the detected event.

By virtue of the techniques described herein, an autonomous vehicle can be configured to provide outputs in scenarios that could, without context, cause a passenger to take certain actions (e.g., engage an emergency stop button, reach out to an individual ready to provide remote assistance to passengers, etc.) when the passenger does not feel the autonomous vehicle is operating as intended. As a result, vehicle operation can continue without interruption and, in the case of communication with the individual ready to provide remote assistance to passengers, network traffic can be eliminated.

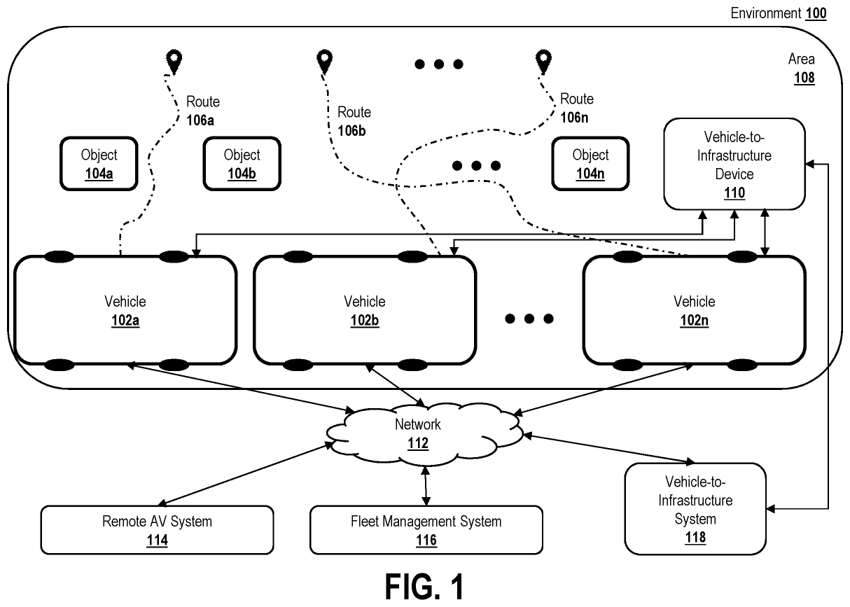

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

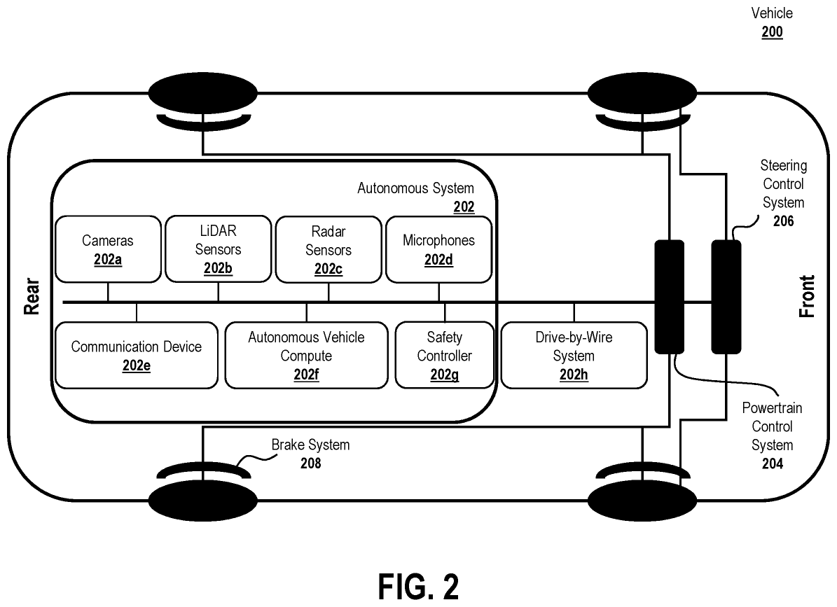

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operation or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

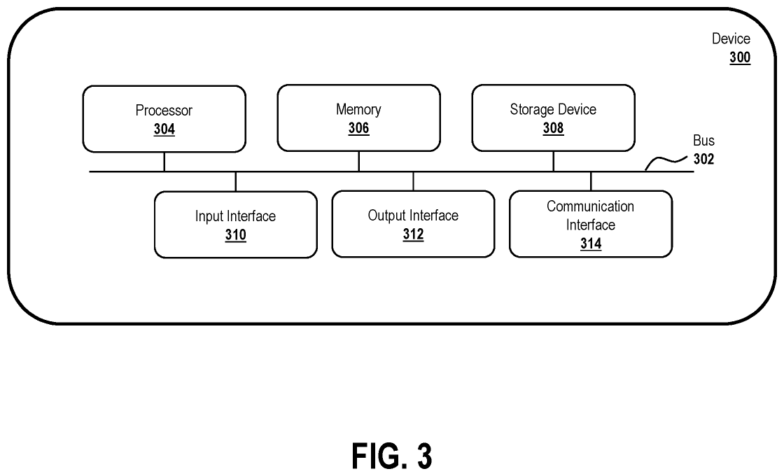

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charged-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is configured to implement autonomous vehicle software 400, described herein. In an embodiment, autonomous vehicle compute 202 f is the same or similar to distributed computing architecture, described in Appendix A and Appendix B. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

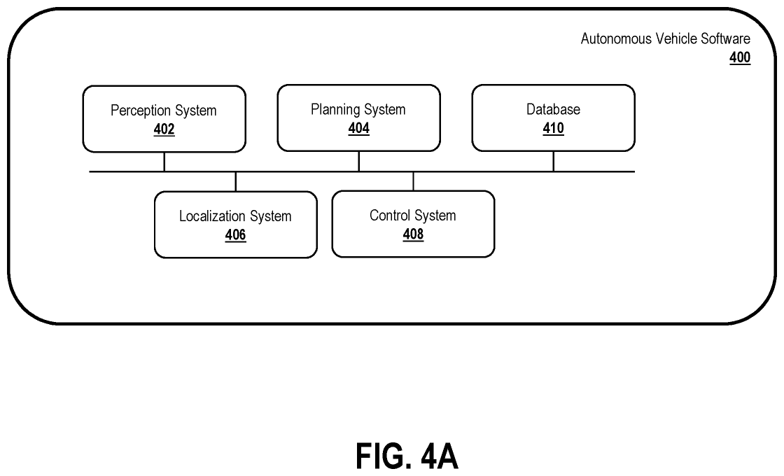

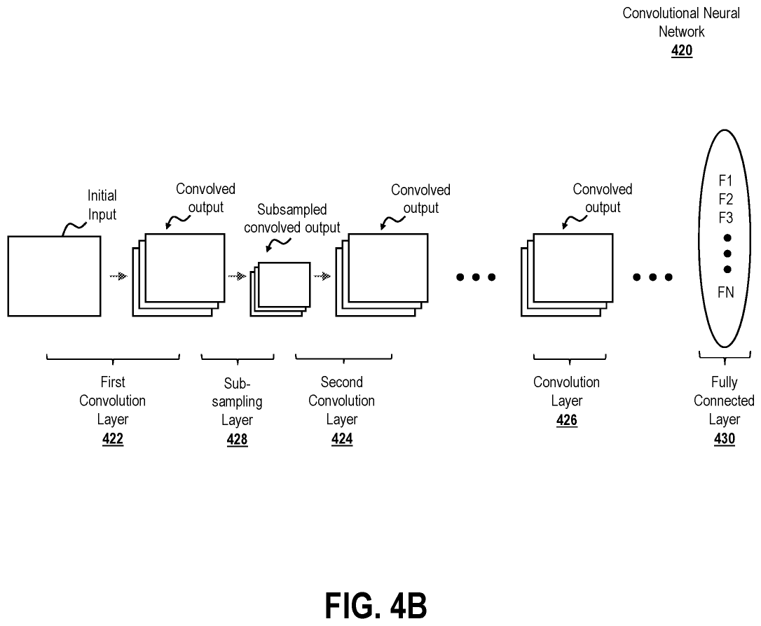

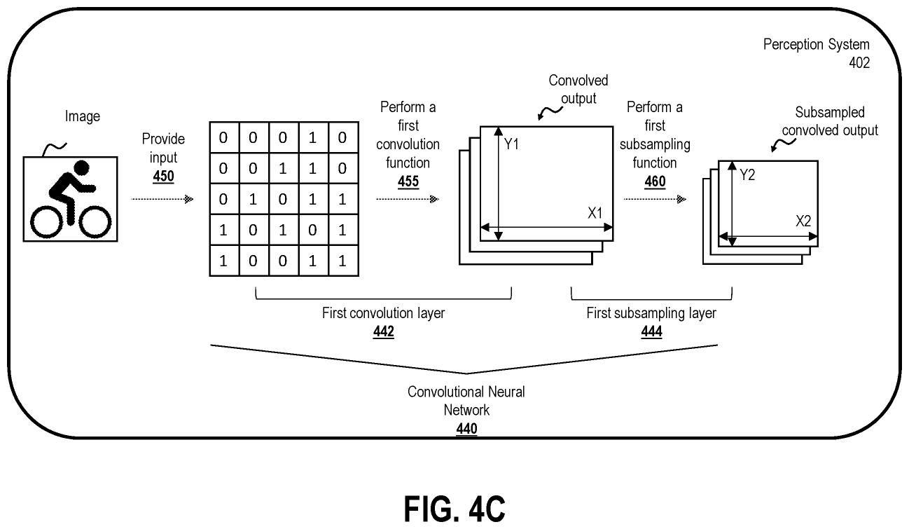

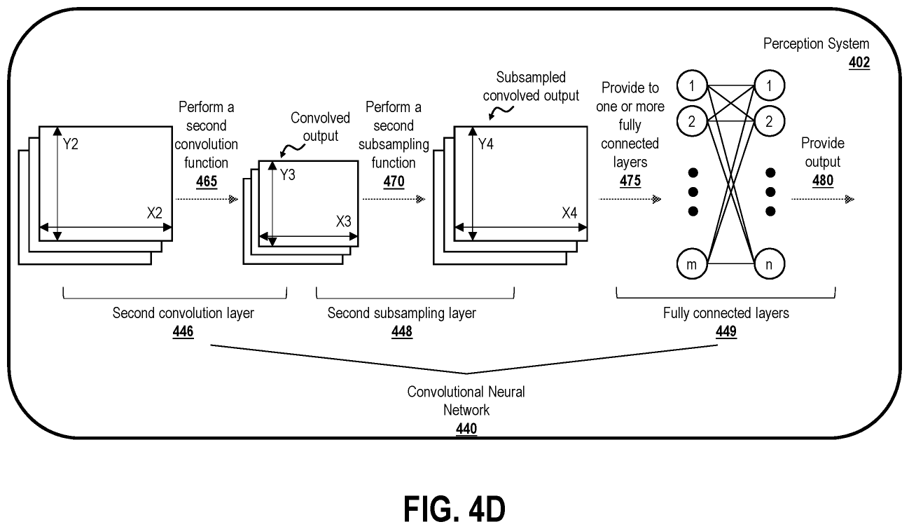

Referring now to FIG. 4A, illustrated is an example block diagram of an autonomous vehicle software 400 (sometimes referred to as an “AV stack”). As illustrated, autonomous vehicle software 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments, perception system 402, planning system 404, localization system 406, control system 408, and database 410 are included in one or more standalone systems (e.g., one or more systems that are the same as or similar to autonomous vehicle software 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle software 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle software 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle software 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

Being a passenger in a non-autonomous vehicle typically requires a trust in the driver. During the ride, the passenger's trust varies depending on how well the driver navigates and reacts to traffic scenarios, how informed they are about the risk level, among other factors. This is especially important when there are unexpected events that may cause uncertainty, anxiety and/or panic in the passenger. A “good” driver may give an explanation as to what happened, and reassure the passenger that they are in control of the situation. In a driverless ride, such explanation from a human driver is not available.

In some embodiments, the current subject matter may be configured to provide a notification system that may provide notifications to the passengers riding in autonomous vehicles to keep them informed of various decisions made by the autonomous vehicle's systems. It may be used to reassure passengers during unexpected events in a way natural to their existing experience with human drivers can make people be more willing to take a ride in an AV. The current subject matter may be configured to determine and/or define various moments of uncertainty (MoU) that may be experienced by passengers and include a framework for the severity levels of each MoU type.

In some example embodiments, the current subject matter may be configured to detect when a moment of uncertainty occurs and determine the cause(s) of the event. It may also identify the severity level and a predicted effect on the passenger. Further, the current subject matter may be configured to trigger a multi-modal message via one or more of vehicle interfaces (e.g., disposed inside the vehicle) to acknowledge the event's occurrence and generate and provide (e.g., display, play an audio message, etc.) an explanation to the passenger. In some example embodiments, the current subject matter may be further configured to provide a default, optimal messaging setting for first time riders in autonomous vehicles and returning riders, and an ability to customize the types, modalities, and/or frequencies based on one or more user preferences.

An acknowledgement of an event may be generated and/or presented to the passenger before, during, and/or after the event has occurred. For example, a message to the passenger of “We're about to go over a speed bump” may be indicative of an expected event that is about to occur. A message of “We braked to avoid a cat” may be indicative of an event that has occurred (e.g., the vehicle stopped). The explanation of the event (e.g., a message presented to the passenger) may be generic and/or specific. For example, a message of “We braked to avoid a cat” may be more specific in nature. However, a message of “We braked to avoid an obstacle” may be more general in nature.

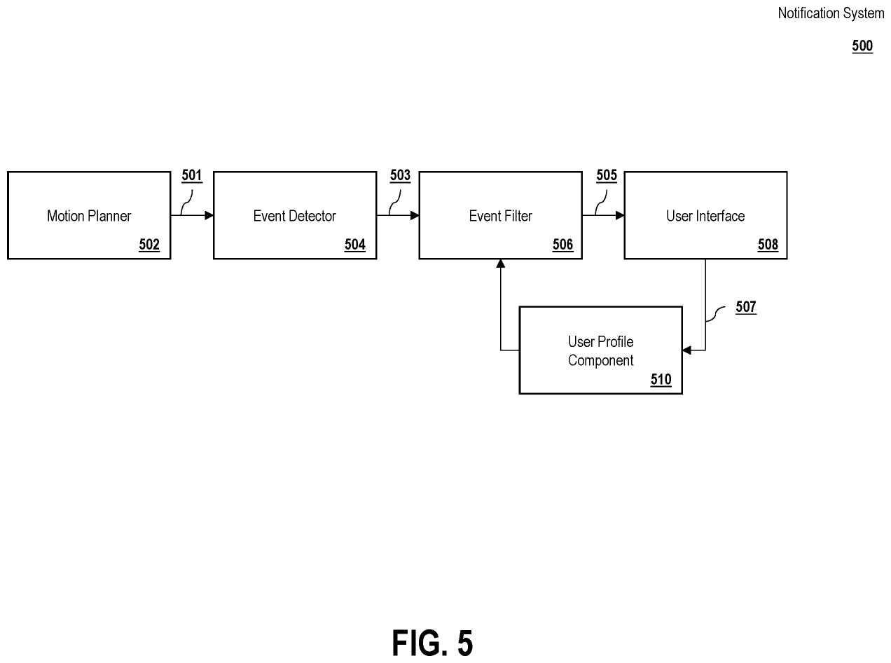

FIG. 5 illustrates an example notification system 500, according to some embodiments of the current subject matter. The system 500 may be incorporated into and/or may use one or more components shown in FIGS. 1-4D. For example, one or more components of the system 500 may be incorporated into one or more vehicles 102, vehicle-to-infrastructure device 110, network 112, remote AV system 114, fleet management system 116, vehicle-to-infrastructure system 118, as shown in FIG. 1. Alternatively, or in addition, the system 500 may be incorporated into one or more components of the autonomous system 202 of the vehicle 200 and/or drive-by-wire system 202h shown in FIG. 2. Further, one or more components of the system 500 may be incorporated into one or more components of the device 300 shown in FIG. 3 and/or one or more components of the autonomous vehicle software 400 shown in FIG. 4A, and/or one or more systems 420 and/or 402 shown in FIGS. 4B-4D.

Referring back to FIG. 5, the system 500 may include a motion planner component 502 (e.g., similar to the planning system 404 shown in FIG. 4A), an event detector component 504, an event filter component 506, a user interface component 508, and a user profile component 510. Each of the components 502-510 may be communicatively coupled to one another using one or more communication links (e.g., wireless and/or wired).

The motion planner component 502 can include one or more devices (e.g., device 300 of FIG. 3) configured to acquire or to receive (e.g., from one or more other components of the autonomous vehicle, shown, for example, in FIGS. 1-4D, such as sensors, cameras, etc.) data related to the surrounding environment of the vehicle (e.g., vehicle 200 of FIG. 2). The data related to the surrounding environment of the vehicle can include travel lane data, travel direction data, travel destination data, obstacle data (e.g., other vehicles, pedestrians, and/or any other moving and/or non-moving objects), as well as any other data. The motion planner component 502 may also acquire various other data that may be related to the state of the vehicle's health (e.g., tire pressure, fuel capacity, operational capacity, etc.).

The motion planner component 502 can be configured to process the acquired data to generate data packets 501. The data packets 501 include a travel trajectory of the vehicle, metadata associated with the travel trajectory of the vehicle, and, optionally, the data acquired from one or more other components of the vehicle (e.g., sensors, cameras, etc.). The travel trajectory may include a current travel trajectory (e.g., currently going straight), and/or global trajectory (e.g., going from point A to point B). The metadata may include, for example, the ‘vehicle's coordinates, speed of the vehicle, metadata indicative of the vehicle's heath, various data related to the vehicle's surrounding environment (e.g., location of moving and/or non-moving objects, possible projected movement paths of any objects in the vehicle's environment, etc.) as well as any other information. The data packets 501 may be represented as time-series data that may be continually generated by the motion planner component 502. The motion planner component 502 may be configured to transmit the data packet(s) 501 to the event detector component 504.

The event detector component 504 can include one or more devices that is the same as, or similar to, device 300 of FIG. 3. The event detector component 504 can be communicatively coupled with the motion planner component 502. The event detector component 504 can be configured to identify one or more patterns in the time-series data received from the motion planner component 502. The patterns may be representative of various movement patterns of the vehicle (e.g., braking, acceleration, turning, avoidance maneuvers, etc.). In some embodiments, the patterns may be representative of various objects and/or movement patterns associated with one or more objects that may be identified as being present in the vehicle's environment. The identification of patterns may be performed using one or more machine learning, neural networks, and/or any other components, such as those shown in FIGS. 4B-4D.

The event detector component 504 can process the identified patterns to detect one or more events that can be classified based on a potential interference with the movement patterns of the vehicle. For example, such events may include, but are not limited to, pedestrians crossing the road in front of the vehicle, another vehicle passing the vehicle, loud noises (e.g., construction noises, etc.) in the vehicle's environment, and/or any other events. The event detector component 504 may be configured to generate an event data set 503 including the identified events. The event detector component 504 can transmit the event data set 503 to the event filter component 506.

The event filter component 506 can include one or more devices that is the same as, or similar to, device 300 of FIG. 3. The filter component 506 can be communicatively coupled with the event detector component 504. The filter component 506 may be configured to analyze the set of events 503 to determine a frequency of occurrence of such events. In some embodiments, the event filter component 506 may be configured to determine relevancy of the events, included in the set of events 503, to the particular passenger(s) that may be currently riding in the vehicle. The relevancy may be based on the profile of the passenger, e.g., the passenger may be a frequent rider and does not want to be bothered with messaging from the system 500 unless an accident has occurred, thereby making most events irrelevant to the passenger. Alternatively, or in addition to, the passenger may be a first time rider in the autonomous vehicle and may want to be informed of every single maneuver that the vehicle makes, thereby making most events highly relevant to the passenger. In some embodiments, the event filter component 506 may be configured to analyze the events that may occur within a predetermined period of time and determine that the events may be merged together and/or omitted in part and/or in whole. The filter component 506 can receive, from the user interface 508, and/or the user profile component 510 a user input that may indicate and/or include a passenger's preference as to particular categories of events that the passenger would like to receive notifications about to filter the events.

The user interface 508 can include any combination of an input interface 310, an output interface 312, and a communication interface 314, as described with reference to FIG. 3. The user interface 508 can include an input interface (e.g., input interface 310 described with reference to FIG. 3), such as a component that permits the example notification system 500 to receive information, such as via user input (e.g., a touchscreen display, a keyboard, a keypad, a mouse, a button, a switch, a microphone, a camera, and/or the like) indicative of a preference of an (e.g., authenticated) passenger of the vehicle. Additionally or alternatively, in some embodiments user interface 508 can include an output interface (e.g., output interface 312 described with reference to FIG. 3) that includes a component that provides output information (e.g., event notifications) from the example notification system 500 (e.g., a display, a speaker, one or more light-emitting diodes [LEDs], and/or the like).

The user profile component 510 can include a database that can store passenger's preference received from the user interface 508 and can be accessed by the filter component 506. For example, the user profile component 510 (e.g., database 410 described with reference to FIG. 4) can be configured to store data sent by the user interface 508 including event types and/or notification period. In some embodiments, the user profile component 510 can include a storage component (e.g., a storage component that is the same as or similar to storage component 308 described with reference to FIG. 3) that stores data and/or software related to the operation and uses of the example user authentication system 500.

With continued reference to FIG. 5, one or more functions will be described as being performed by the example notification system 500. The number and arrangement of the components and/or devices of the example notification system 500, shown in FIG. 5 are provided as an example. There may be additional systems and/or devices, fewer systems and/or devices, different systems and/or device, or differently arrangement systems and/or devices than those shown in FIG. 5. Furthermore, two or more systems and/or devices show in FIG. 5 may be implemented within a single system or a single device, or a single system or a single device shown in FIG. 5 may be implemented as multiple, distributed systems or devices. Additionally, or alternatively, a set of systems or a set of devices (e.g., one or more systems, one or more devices) of the example notification system 500 may perform one or more functions described as being performed by another set of systems or another set of devices of the example notification system 500.

The user profile component 510 may be accessed by the passenger through the user interface component 508 to allow the passenger to enter one or more preferences 507 about notifications that the passenger would like to receive notifications about on the user interface component 508. Once entered, the preferences 507 may be transmitted to the event filter component 506 that may use the preferences 507 to tailor notifications that may be provided using the user interface component 508. Alternatively, or in addition, the preferences 507 may include feedback received from the passenger riding in the vehicle. For example, the feedback may be responsive to a previous notification that has been generated and presented to the passenger using user interface component 508. The feedback may also be indicative of a notification that the passenger would like to receive but has not received upon observing a particular event.

In some embodiments, the components 502-506 may be configured to retrieve, from the user profile component 510, information about historical events to determine whether or not a particular notification may be needed to be presented to the passenger of the vehicle, using user interface component 508. The historical data may be processed, by the event filter, using one or more machine learning, neural networks, etc. components (e.g., as shown in FIGS. 4B-4D), to generate various predictions that may be associated with various aspects (e.g., travel trajectories, etc.) associated with the vehicle and/or any other objects in the vehicle's environment. The components 502-506 may be configured to use such predictions for eventual purposes of generating a notification 505 for presentation on the user interface component 508.

If the event filter component 506 a notification about an event (and/or group of events) to be transmitted to the passenger riding in the vehicle needs to be notified of a particular, the event filter component 506 can transmit the identified notification 505 to the user interface component 508 (e.g., a display device and/or the like). The user interface component 508 may be configured to present the generated notification 505 to the passenger. The presentation may be via a video, an audio, an image, a text, and/or using any other media.

In some example embodiments, if multiple (e.g., associated and/or simultaneous) events may be occurring, the notification system 500 (or one or more components thereof) may be configured to determine the respective level of priority and/or severity and present notifications about the events. For example, events having a higher level of priority and/or severity may be presented to the passenger first and the presentation of other (e.g., associated and/or simultaneous) events may be queued to be displayed with a delay and/or omitted (e.g., based on user preferences, and/or any other factors) from display (if having a level of priority and/or severity is below a set threshold).

In some embodiments, the event filter component 506 can adjust a generation of the notifications 505, based on a combination of the level of priority and/or severity events and a frequency of events (e.g., of a particular level of priority and/or severity). For example, if the number of critical events (e.g., exceeding a maximum level of severity) exceeds an event frequency threshold, the notification 505 can be adjusted to join multiple events and/or silence events for a set period of time. The event filter component 506 can provide an indication to the user interface component 508 to adjust a generation of the notifications 505 based on the event category and/or type. For example, for event categories with high impact (e.g., high degree of abruptness), the event filter component 506 can provide an instruction to the user interface component 508 to play an audio message. As another example, for event categories with lower degree of impact (e.g., debris hit detection), the event filter component 506 can provide an instruction to the user interface component 508 to provide the notification only visually, to minimize a potential disruption.

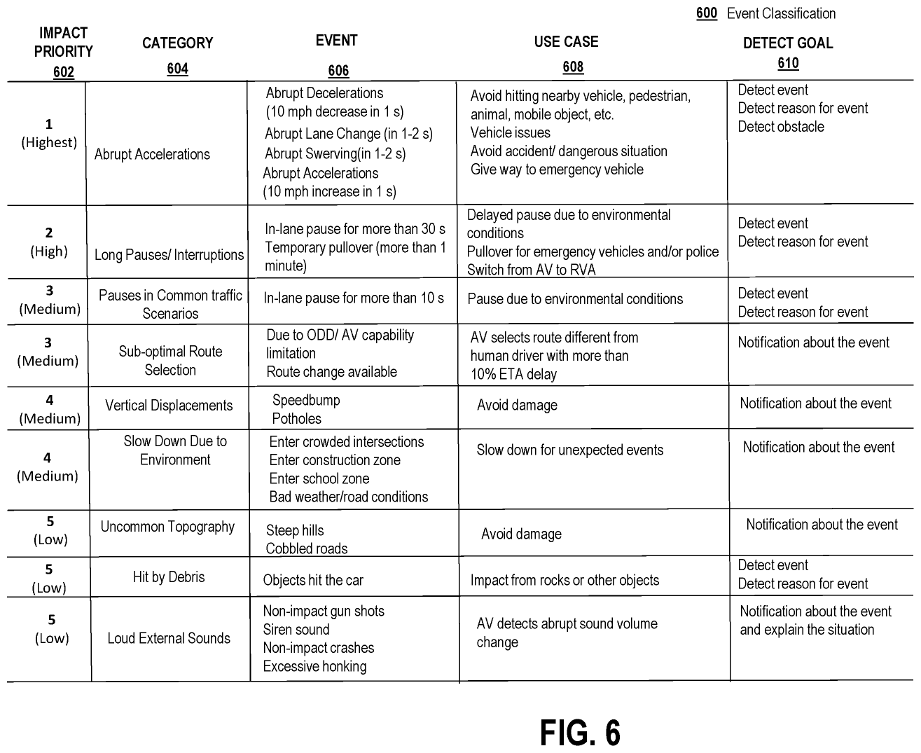

In some embodiments, the event filter component 506 can adjust a generation of the notifications 505, based on an agent type and, optionally, a passenger type. If multiple agents are in the vehicle's environment, the event filter component 506 can adjust a generation of the notifications 505, based on an identification of particular agents (e.g., most relevant agents) that may detected in the vehicle's environment and thus, may affect presentation of various notifications 505. If multiple passengers are in the vehicle, the event filter component 506 can adjust a generation of the notifications 505, based on an identification of particular passengers that may be within the vehicle, and thus, may affect presentation of various notifications 505 to the selected passengers. The event filter component 506 may be configured to analyze each detected event and determine a particular value associate with its severity/priority and compared to one or more thresholds associated with severity/priority. If a threshold for a particular detected event is exceeded, a notification may be provided for presentation to the passenger (e.g., an abrupt stop by the vehicle due to a pedestrian jumping in front of it on the road). More details about the event classification according to different levels of priority are provided with reference to FIG. 6.

FIG. 6 illustrates an example notification table 600 showing an example of event classification according to multiple levels of priority and/or severity that may be assigned to a particular uncertainty event. The example notification table 600 can be generated by an event filter component, such as the event filter component 505 described with reference to FIG. 5. Each event level of priority and/or severity may be associated with a particular threshold value. The threshold values can be used by the s event filter component to generate a notification (e.g., notification 505) for presentation to the passenger, using a user interface (e.g., user interface 508 described with reference to FIG. 5).

The levels of priority and/or severity 602 can correspond to event categories 604, such as an abrupt acceleration, long pauses (ride interruptions), pauses in common traffic scenarios, sub-optimal route selection, vertical displacements, slow down due to environment, and/or other categories describing a vehicle movement change. Each category 604 can include multiple scenarios 606, each scenario being associated with a particular use case 608, and a detection goal 610. The levels of priority and/or severity 602 can be associated to a numerical ranking, where a lowest numerical value (e.g., zero) is associated with a highest event level of priority and/or severity. In some embodiments, multiple categories 605 can have equal levels of priority and/or severity 602 (e.g., equal numerical values) indicating similar ranking for the purpose of notification filtering. For example, pauses in common traffic scenarios and sub-optimal route selections can be equally filtered for selecting notifications to be provided for the user interface, if the user preferences exclude a preference associated with the equally ranked event categories.

In some embodiments, an abrupt acceleration category (e.g., abrupt sudden stops, abrupt lane changes, etc.) can be associated with movements by the autonomous vehicle that may be considered to have a maximum level of priority/severity that the passenger may need to be informed about 602 (e.g., having a high threshold value). As another example, loud external sounds category (e.g., sirens, crashes, etc.) may be considered a lower level of priority/severity 602 (e.g., having a lower threshold value), about which the passenger riding in the autonomous vehicle might not be as interested in as in those events associated with the higher level of priority/severity.

As can be understood, the example notification table 600 is provided here as an example, for non-limiting purposes and any other types of priority/severity and associated threshold values may be assigned to and/or determined for events and/or may be customized by the passenger. Moreover, depending on various events and/or circumstances of surrounding such events, the current subject matter system may be configured to dynamically make appropriate decision concerning levels of priority/severity associated with a particular event.

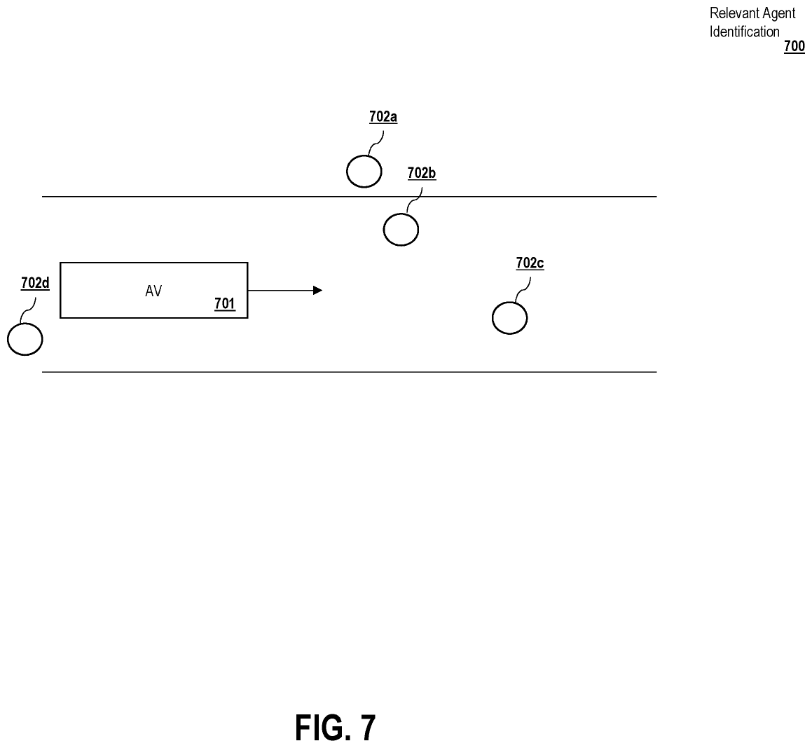

FIG. 7 illustrates an example environment 700 for determination of relevance of each agent, according to some embodiments of the current subject matter. The environment 700 may include an autonomous vehicle (AV) 701 (which may be similar to one or more vehicles and/or components discussed above with regard to FIGS. 1-4D) that may be travelling in a particular direction (e.g., as indicated by the arrow in FIG. 7). The AV 701 may include one or more components of the system 500 shown in and discussed above in connection with FIG. 5.

The example environment 700 may also include one or more agents 702 (a, b, c, d). The agents 702 may include moving objects, non-moving objects, and/or stationary objects. The agents 702 may include, but are not limited to, pedestrians, animals, other vehicles, trees, posts, curbs, etc. For example, the agent 702a may be a pedestrian walking along the road. Agent 702d may be another vehicle travelling behind the AV 701. Agent 702b may be another vehicle travelling in front of the AV 701. Agent 702c may be another pedestrian that may be finishing crossing the road, on which the AV 701 is travelling.

The AV 701, including or coupled to the example notification system 500 shown in FIG. 5, can determine a relevance of each agent 702. For example, the AV 701 can determine how a particular agent 702 is relevant to the AV 701 and whether or not to notify the passenger riding in the AV 701. The AV 701 may be configured to use various processes, such as, for example, an ST constraint domain process, whereby the most dominant constraint that limits the AV 701 behavior may be selected as the reason for determining relevance of a particular agent. For example, vehicle 702b may be determined as the most relevant to the behavior of AV 701, because it is riding in front of the AV 701 and might not allow certain maneuvers by AV 701. Alternatively or in addition to, eliminating agents 702 to determine whether the agents 702 contribute to the behavior of AV 701 may also be used to filter out notifications. The agent elimination process may include a linear elimination of agents 702 and/or grouped elimination of agents 702 where one or more groups of agents 702 may be selected using a heuristic. For example, agent 702d may be eliminated as potentially not affecting the behavior of the AV 701, unless particular aspects about the agent 702d are determined to be contributory to the AV 701 behavior. The agents 702b and 702c may potentially be grouped together as affecting behavior of the AV 701 because both of them are on the road that is being used by the AV 701. In some embodiments, data and/or information about agents may be used to generate various triggers associated with events and use such triggers for the purposes of providing notification to the passengers riding in the vehicle using a user interface component (e.g., user interface component 508, as shown in FIG. 5).

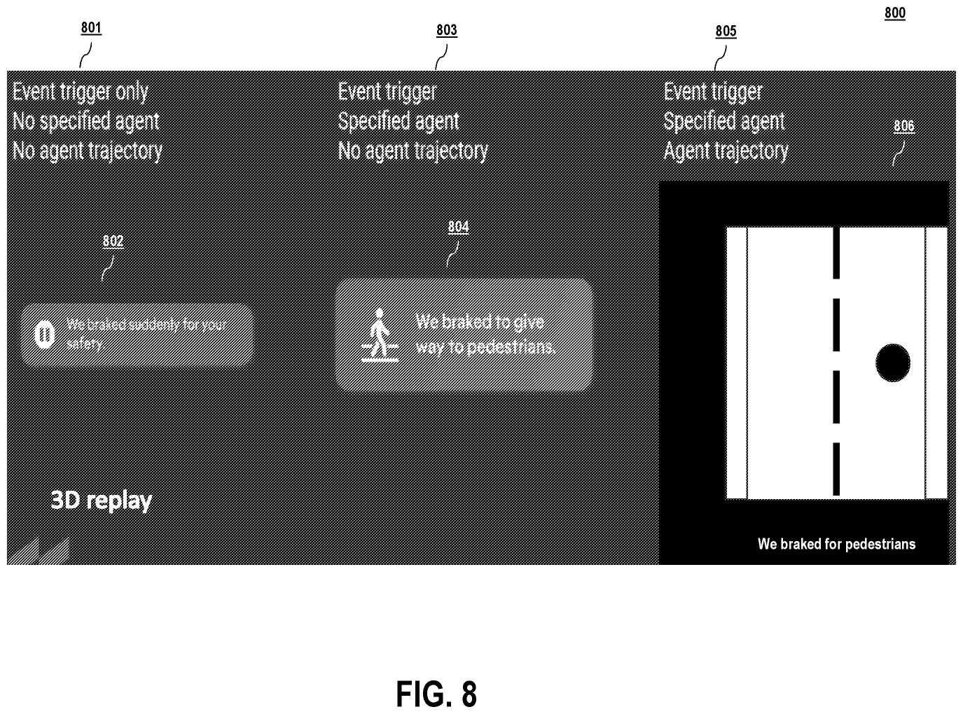

FIG. 8 illustrates examples of event triggers 800 and other parameters that may be used to generate various notifications that may be displayed using a user interface (e.g., user interface component 508, described with reference to FIG. 5). As illustrated, the notifications can be categorized based on event trigger, selected agents, and agent trajectory. As shown in FIG. 8, an example of a notification 802 (“We braked suddenly for your safety”) that may be displayed using the user interface component may be associated with an event trigger 801, without being associated with a particular agent and/or agent's travel trajectory. The example notification 802 can include a textual portion and an action symbol (e.g., brake icon) portion. Another example of a notification 804 (“We braked to give way to pedestrians” along with an icon) may be associated with an event trigger 803 that may be associated with a particular agent but no agent trajectory. The example notification 804 can include a textual portion and an agent symbol portion including an agent icon (e.g., pedestrian icon). Another example of a notification 806 (“We braked to give way to pedestrians”) may be associated with an event trigger, a particular agent and agent's trajectory 805 that may have been determined by a notification system (e.g., the example notification system 500 shown in FIG. 5). The example notification 804 can include a textual portion and an agent symbol portion including a graphic (e.g., animated icon).

The above event triggers maybe useful in the following examples of non-limiting scenarios. One such scenario involves abrupt accelerations. Abrupt accelerations may be events with an abrupt change in velocity, longitudinally or latitudinally (e.g., abrupt braking, abrupt swerving, etc.). In the abrupt acceleration situations, the notification system may be configured to acknowledge the abrupt event, and provide a reason as to why the event has occurred. The reason included in the textual portion of the notification may be either generic and/or specific. The abrupt events can be triggered any multiple factors, from internal AV issues to external agents within the vehicle's environment. In case of abrupt behaviors due to external agents, such as, for example, braking to avoid hitting an animal (crossing the road) and/or yielding to a jaywalker, the system 500 may be configured to specify the agent as well as their travel trajectory (e.g., a current trajectory, a historical trajectory, a predicted future trajectory, and any combination thereof). The specificity and accuracy of the information included in the notifications communicated to the passenger through the user interface, can increase the confidence of the passenger in the processing of the event.

Another example of notifications may involve long pauses. A notification about long pauses may include, for example, “We're driving extra cautiously for safety.” During an AV ride, a long pause may cause passenger anxiety. Depending on the length and cause of the pause, the notification system may be configured to acknowledge the situation and provide a notification indicating that the situation is normal for AV rides or the situation is not normal and someone (e.g., a remote vehicle assistant (RVA)) is looking into solving the problem. If RVA is resolving an issue, the passenger may also be kept informed through various notifications that may be provided using the user interface component.

A further example of a notification can be associated with a vertical displacement. As can be understood, artifacts on the road surface, such as speed bumps, potholes, road cracks or connectors between different types of surfaces can cause vertical displacement and thus discomfort to the passengers of the vehicle. The notification system may provide vertical displacement notifications to make the passenger aware prior to the event. The severity of the notification may depend on the planned speed of the vehicle and the surface profile of the artifact. For example, if the notification system detected an obstacle on the road (e.g., a speed bump), the user interface component may be configured to display a notification to that effect (“We're about to go over a speed bump”).

Another example of a notification may involve slowdowns due to environment conditions. The environment can include multiple factors that might trigger the AV to slow down, some of which might not be obvious to the passengers. The notification system may be configured to provide explanations and transparency as to the factors that triggered the AV to slow down, for a potential and/or non-obvious event. In addition to the reason, the notification can include the duration and the extent of the slow down. For example, driving next to a sidewalk with pedestrians may be one such scenario. In nominal cases, the notification system might not expect the pedestrian to enter the road surface, however, the behavior and motion prediction of the AV might deem that based on the pedestrians behavior it may need to slow down to avoid a collision or abrupt braking.

In some embodiments, driving next to parked vehicles might impose a high risk of collision or abrupt braking as the parked vehicles could suddenly move or a pedestrian/cyclist could step out from an area occluded by the parked vehicles. The vehicle may choose to slow down and the notification system may provide an appropriate notification to the passenger.

Further, approaching a traffic light, which is not yet visible to the passenger may be another example of a cause for slow down. The AV might be aware statistical, locally shared, or other timing information that can be processed to slow down the AV to maximize comfort of efficiency and the notification system may provide an appropriate notification to the passenger.

As another example, the AV may slow down to make space for a vehicle that is cutting in front of the vehicle both for courtesy or defensive driving and the notification system may provide an appropriate notification to the passenger.

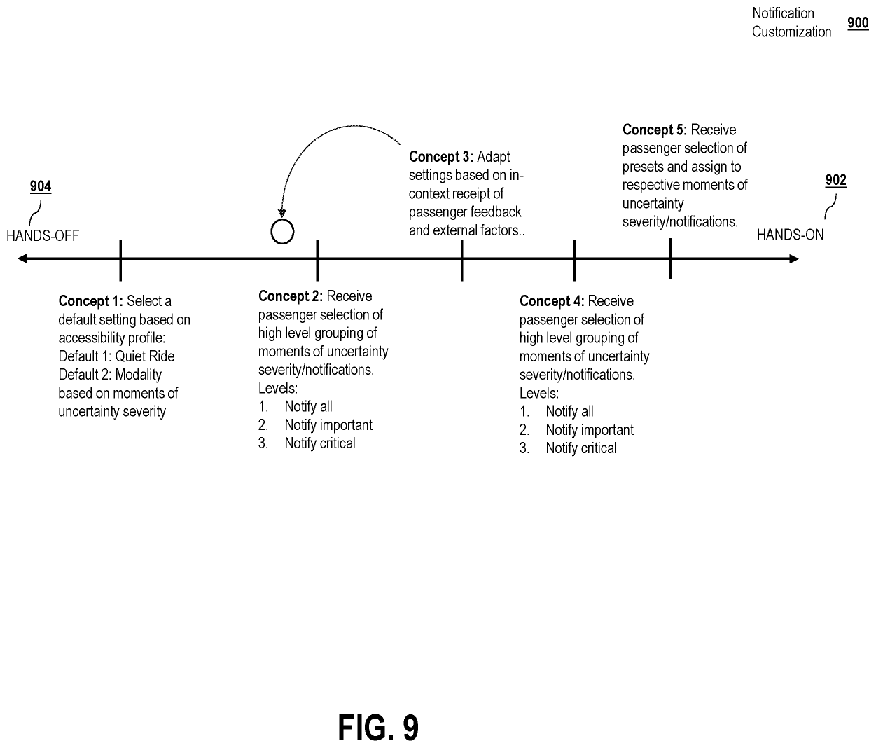

In some embodiments, as illustrated in FIG. 9, the notification system (e.g., notification system 500 shown in FIG. 5) may be configured to provide the passenger with an ability to customize notifications that the passenger may wish to receive. For example, for the first time riders who have not experienced riding in an AV before, the notification system may be configured to explain (e.g., via the user interface component 508) AV behaviors and decisions that are different from human drivers, both visually and audibly according to hands-on settings 902. The selected notification setting may educate the passenger about AV technology. For returning riders who are already familiar with AV technology, the frequency and modality of the notification system may be altered based on priority and commonalities of the events according to hands-off settings 904. For example, high priority (#1 and #2) and/or rare events (as shown in FIG. 6) may still have visual and audio explanation, while low priority (#3 onwards) and common events may be visual-only, and/or skipped altogether.

In some embodiments, the notification system may include settings that may be adaptive to route types and area characteristics, which may have different types of events and level of rarity. For example, in an urban area where there are a lot of speed bumps and complex intersections, the notification system may only provide notifications the first time it happens, and incorporate a “cool down” time if the event happens consecutively in a short amount of time (e.g., within 1 minute). The notification frequency adjustment may help reduce the amount of communication that may disrupt a passenger's experience, especially for returning riders.

In some embodiments, as stated above, the passengers may be able to customize the notification level. For example, some passengers may select, through a user input received by the user interface, to have more updates and controls, while others may select, through a user input received by the user interface, to receive reduced (frequency) notifications about what's happening during the ride.

Thus, the customization that may be afforded by the notification system may range from less to more control by the user, as shown by the notification customization graphic 900 shown in FIG. 9. The customization may range between “hands-off” approach 904, where the passenger selected not to be presented with notifications related to moments of uncertainty (MoU) and “hands-on” approach 902, where the passenger selected to be presented with all notifications. The notification system may adaptively learn from the passengers' live feedback when an event happens, and adjust the notification settings (frequency and notification audio-video delivery mode) accordingly.

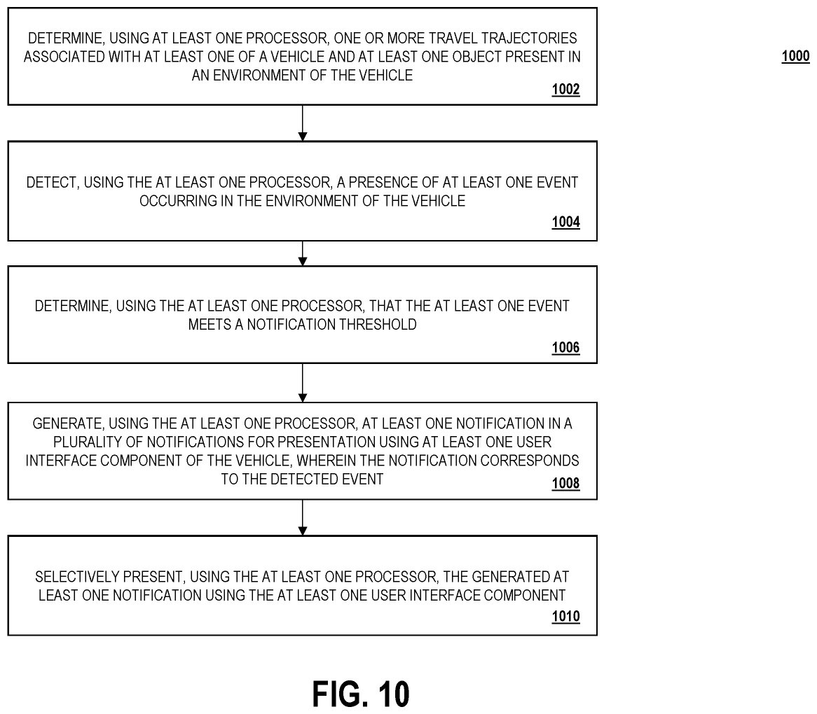

FIG. 10 illustrates an example of a notification process 1000 for generating notifications, according to some implementations of the current subject matter. In some embodiments, one or more of the steps described with respect to the example process 1000 are performed (e.g., completely, partially, and/or the like) by an autonomous system or device or group of devices, as described with reference to FIGS. 1-5. Additionally, or alternatively, in some embodiments, one or more of the steps described with respect to the example process 1000 may be executed by the vehicle 702 (e.g., as shown in FIG. 7 and/or vehicle(s) shown and discussed in connection with FIGS. 1-4D) that may incorporate notification system 500 shown in FIG. 5. For example, one or more of the operations described with respect to process 1000 are performed (e.g., completely, partially, sequentially, non-sequentially, and/or the like) by the notification system 500 that may be capable of selectively presenting notifications to passengers, riders, and/or users inside the autonomous vehicle (AV).

At 1002, a motion planner and/or any other AV component may determine one or more travel trajectories associated with at least one of the vehicle and at least one object (agent) present in an environment of the vehicle. For example, features associated with one or more agents (stationary objects and/or moving objects, pedestrians, animals, etc.) that can be detected by one or more sensing devices (e.g., V2I device 110 described with reference to FIG. 1, cameras 202a, LiDAR sensors 202b, radar sensors 202c, and microphones 202d described with reference to FIG. 2, perception system 402 described with reference to FIG. 4A, vehicle's sensors 502 attached to the vehicle described with reference to FIGS. 5A and 5B). The sensing devices can be attached to or integrated in the vehicle to identify static and mobile agents present in an environment surrounding the vehicle. For example, the sensing devices can monitor parameters associated with the agents relative to the movement of the respective vehicle and parameters associated with the vehicle, to which they are attached. The parameters associated to the environment surrounding the vehicle can include, but are not limited to, parameters associated with movement of other vehicles (e.g., speed, direction, etc.) and/or other objects (e.g., pedestrians, light poles, etc.). The parameters associated with the vehicle can include, but are not limited to, parameters associated with vehicle's state, e.g., heading, driving speed, etc. Additionally, the parameters associated to the vehicle can include, but are not limited to, parameters associated with vehicle's operational status and indicators or potential malfunctions, e.g., tire inflation pressure, oil level, transmission fluid temperature, etc. The data including one or more measured and/or monitored parameters and collected by the sensing devices can transmitted to the notification system (e.g., notification system 500 described with reference to FIG. 5) to be processed as input data (features). The travel trajectory of the vehicle can include a current trajectory, a historical trajectory, a predicted future trajectory, and any combination thereof. The travel trajectory of the vehicle can include a path of travel, direction, speed, and/other movement and/or maneuver parameters that optimize a displacement of the vehicle towards a target position in a safe mode (avoiding collisions) with a minimum cost (shortest travel time to destination, minimal energy consumption, and/or shortest distance). The determined movements of the vehicle can be used to control one or more systems of the vehicle (e.g., steering control system 206 described with reference to FIG. 2) to control the vehicle to execute the determined movements. One or more movements of the vehicle can be adjusted based on the ranking of the agents and can lead to notifications.

At 1004, a presence of at least one event (e.g., pedestrian crossing the road, upcoming vertical displacement, etc.) occurring in the environment of the vehicle may be detected. For example, determining an event can include determining one or more output features (vehicle braking) based on an interaction between the one or more agents and the AV. The output features associated with the one or more agents can include speed change and/or a trajectory change relative to the agents identified within the environment. The output features can be adjusted based on a predicted behavior relative to the state of other agents. For example, the output features can be generated using a model of agent interactions implemented in an agent importance prediction component.

At 1006, a determination is made that the detected event may meet a notification threshold (e.g., the detected event is significant enough to be reported to the passenger). The notification determination may be made based on various levels of severity and/or event priority illustrated in example notification table 600 FIG. 6. For example, higher priority and/or severity events (e.g., #1 and #2 in table 600) may have a higher threshold, whereas lower priority and/or severity events (e.g., #3 and beyond) may have a lower threshold to meet. The notification threshold can be associated with at least one of a priority and a severity of the at least one detected event. The notification determination relative to the importance of the detected event can be adjusted relative to passenger types and passenger preference settings, as described with reference to FIG. 9. The notification determination relative to the importance of the detected event can be adjusted relative to a frequency of a particular event type and/or frequency of associated (linked) events including at least one detected event. For example, multiple events can be aggregated within a single notification. The events with high significance scores can be defined as events that can have a high impact on the passenger. In some embodiment, the notification determination can include a determination of a notification mode (audio, visual, and/or haptic).

At 1008, at least one notification in a plurality of notifications for presentation using at least one user interface component of the vehicle can be generated. The notification can be provided for presentation of a single or multiple (grouped) events.

At 1010, the notification may be selectively presented to the passenger, rider, user, etc. (e.g., based on user preferences) using the user interface component. Selectively presenting the notification can include determining one or more preferences associated with presenting the one or more notifications in the plurality of notifications. Selectively presenting the notification can include executing using the one or more determined preferences presenting the notification using the at least one user interface component or preventing a presentation of the at least one notification. Selectively presenting the notification can include presenting (providing for display) the at least one generated notification in accordance with the at least one determined priority and the severity of the at least one detected event. The notification can be provided for presentation using a textual description of an event and/or a symbol (static or animated icon) associated with the event. The user interface component can be configured to receive a user input including user preferences indicating preferred notification settings. The preferred notification settings can be used to adjust a frequency and a mode (audio, visual, and/or haptic) of a presentation of future notifications.

The current subject matter system may be configured to have one or more advantages and/or benefits to various levels of passengers, users, riders (e.g., first time riders to more experienced AV riders). For example, first time AV riders' focus may be on the road and not on the passenger display. Unlike a conventional systems, the current subject matter may be configured to build trust without getting in the way of first-time riders' inclination to focus on the AV's driving. The current subject matter may be configured to highlight the AV's intelligence, by informing riders that it can “scan ahead,” that it can see and identify certain objects and that it is aware when moments are potentially concerning for riders. The described example systems may have a high accuracy, which may increase confidence in the vehicle's intelligence. Further, the current subject matter may be configured to provide critical communications to the passengers in terms that laypeople can understand. Without such system, passengers may be more likely to call an agent for any concerns that arise. The system may also be advantageous for riders with disabilities (e.g., visually-impaired, etc.). Such system may make the riders feel significantly less alone when they are in an AV for the first time.

According to some non-limiting embodiments or examples, provided is a system, comprising: at least one processor, and at least one non-transitory storage media storing instructions that, when executed by the at least one processor, cause the at least one processor to perform operations comprising: determining, using at least one processor, one or more travel trajectories associated with at least one of a vehicle and at least one object present in an environment of the vehicle; detecting, using the at least one processor, a presence of at least one event occurring in the environment of the vehicle; determining, using the at least one processor, that the at least one event meets a notification threshold; generating, using the at least one processor, at least one notification in a plurality of notifications for presentation using at least one user interface component of the vehicle, wherein the at least one notification corresponds to the detected at least one event; and selectively presenting, using the at least one processor, the at least one notification using the at least one user interface component.

According to some non-limiting embodiments or examples, provided is at least one non-transitory storage media storing instructions that, when executed by at least one processor, cause the at least one processor to perform operations comprising: determining, using at least one processor, one or more travel trajectories associated with at least one of a vehicle and at least one object present in an environment of the vehicle; detecting, using the at least one processor, a presence of at least one event occurring in the environment of the vehicle; determining, using the at least one processor, that the at least one event meets a notification threshold; generating, using the at least one processor, at least one notification in a plurality of notifications for presentation using at least one user interface component of the vehicle, wherein the at least one notification corresponds to the detected at least one event; and selectively presenting, using the at least one processor, the at least one notification using the at least one user interface component.

According to some non-limiting embodiments or examples, provided is a method, comprising: determining, using at least one processor, one or more travel trajectories associated with at least one of a vehicle and at least one object present in an environment of the vehicle; detecting, using the at least one processor, a presence of at least one event occurring in the environment of the vehicle; determining, using the at least one processor, that the at least one event meets a notification threshold; generating, using the at least one processor, at least one notification in a plurality of notifications for presentation using at least one user interface component of the vehicle, wherein the at least one notification corresponds to the detected at least one event; and selectively presenting, using the at least one processor, the at least one notification using the at least one user interface component.

Further non-limiting aspects or embodiments are set forth in the following numbered clauses:

Clause 1. A method comprising: determining, using at least one processor, one or more travel trajectories associated with at least one of a vehicle and at least one object present in an environment of the vehicle; detecting, using the at least one processor, a presence of at least one event occurring in the environment of the vehicle; determining, using the at least one processor, that the at least one event meets a notification threshold; generating, using the at least one processor, at least one notification in a plurality of notifications for presentation using at least one user interface component of the vehicle, wherein the at least one notification corresponds to the detected at least one event; and selectively presenting, using the at least one processor, the at least one notification using the at least one user interface component.

Clause 2. The method of clause 1, wherein the at least one event is associated with at least one object in a plurality of objects.

Clause 3. The method of any of the preceding clauses, wherein the one or more travel trajectories comprises: a current trajectory, a historical trajectory, a predicted future trajectory, and any combination thereof.

Clause 4. The method of any of the preceding clauses, wherein the at least one object comprises at least one of: a moving object, a non-moving object, and a stationary object.

Clause 5. The method of any of the preceding clauses, wherein the at least one notification is generated for a plurality of events comprising the at least one event.

Clause 6. The method of any of the preceding clauses, wherein selectively presenting comprises: determining, using the at least one processor, one or more preferences associated with presenting the one or more notifications in the plurality of notifications; and executing, using the at least one processor, using the one or more preferences at least one of presenting, using the at least one processor, the at least one notification using the at least one user interface component; and preventing, using the at least one processor, presentation of the at least one notification using the at least one user interface component.

Clause 7. The method of any of the preceding clauses, wherein the one or more travel trajectories comprises at least one of: a travel trajectory unassociated with the at least one object, a travel trajectory associated with the at least one object, a travel trajectory executed by the at least one object, and any combination thereof.

Clause 8. The method of any of the preceding clauses, wherein the notification threshold is associated with at least one of a priority and a severity of the at least one event.

Clause 9. The method of any of the preceding clauses, wherein selectively presenting comprises presenting the at least one notification in accordance with the at least one priority and the severity of the at least one event.

Clause 10. The method of any of the preceding clauses, wherein the severity of the at least one event is associated with any of an abrupt acceleration or deceleration, an abrupt swerving, and an abrupt lane change.

Clause 11. A system, comprising: at least one processor, and at least one non-transitory storage media storing instructions that, when executed by the at least one processor, cause the at least one processor to perform operations of any of the preceding clauses, comprising: determining, using at least one processor, one or more travel trajectories associated with at least one of a vehicle and at least one object present in an environment of the vehicle; detecting, using the at least one processor, a presence of at least one event occurring in the environment of the vehicle; determining, using the at least one processor, that the at least one event meets a notification threshold; generating, using the at least one processor, at least one notification in a plurality of notifications for presentation using at least one user interface component of the vehicle, wherein the at least one notification corresponds to the detected at least one event; and selectively presenting, using the at least one processor, the at least one notification using the at least one user interface component.

Clause 12. At least one non-transitory storage media storing instructions that, when executed by at least one processor, cause the at least one processor to perform operations of any of the preceding clauses, comprising: determining, using at least one processor, one or more travel trajectories associated with at least one of a vehicle and at least one object present in an environment of the vehicle; detecting, using the at least one processor, a presence of at least one event occurring in the environment of the vehicle; determining, using the at least one processor, that the at least one event meets a notification threshold; generating, using the at least one processor, at least one notification in a plurality of notifications for presentation using at least one user interface component of the vehicle, wherein the at least one notification corresponds to the detected at least one event; and selectively presenting, using the at least one processor, the at least one notification using the at least one user interface component.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method comprising:
determining, using at least one processor, one or more travel trajectories associated with at least one of a vehicle and at least one object present in an environment of the vehicle;
detecting, using the at least one processor, a presence of at least one event occurring in the environment of the vehicle;
determining, using the at least one processor, that the at least one event meets a notification threshold;
generating, using the at least one processor, at least one notification in a plurality of notifications for presentation using at least one user interface component of the vehicle, wherein the at least one notification corresponds to the detected at least one event; and
selectively presenting, using the at least one processor, the at least one notification using the at least one user interface component.

2. The method of claim 1, wherein the at least one event is associated with at least one object in a plurality of objects.

3. The method of claim 1, wherein the one or more travel trajectories comprises: a current trajectory, a historical trajectory, a predicted future trajectory, and any combination thereof.

4. The method of claim 1, wherein the at least one object comprises at least one of: a moving object, a non-moving object, and a stationary object.

5. The method of claim 1, wherein the at least one notification is generated for a plurality of events comprising the at least one event.

6. The method of claim 1, wherein selectively presenting comprises:
determining, using the at least one processor, one or more preferences associated with presenting the one or more notifications in the plurality of notifications; and
executing, using the at least one processor, using the one or more preferences at least one of
presenting, using the at least one processor, the at least one notification using the at least one user interface component; and
preventing, using the at least one processor, presentation of the at least one notification using the at least one user interface component.

7. The method of claim 1, wherein the one or more travel trajectories comprises at least one of: a travel trajectory unassociated with the at least one object, a travel trajectory associated with the at least one object, a travel trajectory executed by the at least one object, and any combination thereof.

8. The method of claim 1, wherein the notification threshold is associated with at least one of a priority and a severity of the at least one event.

9. The method of claim 8, wherein selectively presenting comprises presenting the at least one notification in accordance with the at least one priority and the severity of the at least one event.

10. The method of claim 8, wherein the severity of the at least one event is associated with any of an abrupt acceleration or deceleration, an abrupt swerving, and an abrupt lane change.

11. A system, comprising:
at least one processor, and
at least one non-transitory storage media storing instructions that, when executed by the at least one processor, cause the at least one processor to perform operations comprising:
determining one or more travel trajectories associated with at least one of a vehicle and at least one object present in an environment of the vehicle;
detecting a presence of at least one event occurring in the environment of the vehicle;
determining that the at least one event meets a notification threshold;
generating at least one notification in a plurality of notifications for presentation using at least one user interface component of the vehicle, wherein the at least one notification corresponds to the detected at least one event; and
selectively presenting the at least one notification using the at least one user interface component.

12. The system of claim 11, wherein the at least one event is associated with at least one object in a plurality of objects.

13. The system of claim 11, wherein the one or more travel trajectories comprises: a current trajectory, a historical trajectory, a predicted future trajectory, and any combination thereof.

14. The system of claim 11, wherein the at least one object comprises at least one of: a moving object, a non-moving object, and a stationary object.

15. The system of claim 11, wherein the at least one notification is generated for a plurality of events comprising the at least one event.

16. The system of claim 11, wherein the one or more travel trajectories comprises at least one of: a travel trajectory unassociated with the at least one object, a travel trajectory associated with the at least one object, a travel trajectory executed by the at least one object, and any combination thereof.

17. The system of claim 11, wherein the notification threshold is associated with at least one of a priority and a severity of the at least one event.

18. The system of claim 17, wherein selectively presenting comprises presenting the at least one notification in accordance with the at least one priority and the severity of the at least one event.

19. The system of claim 17, wherein the severity of the at least one event is associated with any of an abrupt acceleration or deceleration, an abrupt swerving, and an abrupt lane change.

20. At least one non-transitory storage media storing instructions that, when executed by at least one processor, cause the at least one processor to perform operations comprising:
determining one or more travel trajectories associated with at least one of a vehicle and at least one object present in an environment of the vehicle;
detecting a presence of at least one event occurring in the environment of the vehicle;
determining that the at least one event meets a notification threshold;
generating at least one notification in a plurality of notifications for presentation using at least one user interface component of the vehicle, wherein the at least one notification corresponds to the detected at least one event; and
selectively presenting the at least one notification using the at least one user interface component.
